(19) United States
(12) Patent Application Publication
(10) Pub. No.: US 2017/0132427 A1
(43) Pub. Date: May 11, 2017

(54) COMPUTER SYSTEM AND METHOD TO CONTROL ACCESS TO ENCRYPTED FILES

(71) Applicant: Océ Printing Systems GmbH & Co. KG, Poing (DE)

(72) Inventors: Herman Lankreijer, Hofsingelding (DE); Armin Gnaedig, Poing (DE)

(73) Assignee: Océ Printing Systems GmbH & Co. KG, Poing (DE)

(21) Appl. No.: 15/343,777

(22) Filed: Nov. 4, 2016

(30) Foreign Application Priority Data
Nov. 6, 2015 (DE) 10 2015 119140.7

(51) Int. Cl. G06F 21/62; G06F 21/52; H04L 9/08; G06F 21/34

(52) U.S. Cl. CPC G06F 21/6218; G06F 21/34; G06F 21/52; H04L 9/0897; G06F 2221/2107

(57) ABSTRACT

In a method to control access to secure files that are stored on a data storage located in a computer system for storage of files, the stored files accessible with an application, secure files are accessed with a key. Further, a check is performed, using access information linked with the key, as to whether the execution of the application is authorized upon execution of the application.

### CROSS REFERENCE TO RELATED APPLICATIONS

This patent application claims priority to German Patent Application No. 102015119140.7, filed Nov. 6, 2015, which is incorporated herein by reference in its entirety.

### BACKGROUND

The disclosure is directed to methods to control access to files, such as secure files that are stored on a data storage in a computer system, and a computer system that is designed to execute these methods.

Computer systems are known in which files stored on a hard disk are generally encrypted. The files are only accessible in readable form to the operating system and applications when the computer system is in operation and has been unlocked by a trusted user. Given a one-time login of the user at the computer system, the hard disk is unlocked using a password. The data may subsequently be accessed without further limitation.

Furthermore, computer systems generally have a rights administration. Most rights administration systems differentiate the rights for reading, writing and execution of files. There are also rights systems that subdivide the individual access rights more finely, for example into full access, modify, read and execute, list folder content, read, write.

The use of encrypted hard disks may significantly limit the use of the data by unauthorized parties. This offers excellent protection against theft of the hard disk or access by unauthorized third parties. However, encrypted hard disks are only conditionally secure if multiple groups of people have access to the respective computer system.

For example, given security printing systems for printing confidential data, the problem exists that this printing system should be used by different groups or customers. Such security printing systems are often located in hermetically sealed rooms. However, if different groups of people should be able to use the printing system, it then cannot always be ensured that data from one user that are still stored on the hard disk are not accessible to another user.

If a user has the right to read a file of an encrypted hard disk and the right to write to this hard disk, the user may create a copy of the file. The user is then considered as the owner of the copy and then may freely possess the copy, and may also copy it in an unencrypted form to any other data medium.

An additional problem exists in that misbehavior by a user cannot always be precluded, such that there may also be users that—contrary to instructions—copy and remove confidential data.

The more secure the data is against unauthorized access, the more difficult it is to process the data. If all rights are granted to a user, he may process the data in any regard. However, the data is then not secure. In contrast, if a user is granted only severely limited rights, he may then be limited in both the manipulation of the data in both a negative and positive way.

A method and a device for printing sensitive data is described in DE 103 32 850 A1 or the corresponding U.S. Pat. No. 7,657,031 B2. In this method, the data to be printed are generally stored in encrypted form. After the decryption, the data are held only in a volatile memory and are immediately converted into control signals to drive a printing unit, and are relayed to the printing unit. It is thus impossible to extract the encrypted data supplied to the printing device from the printing device, via manipulation at said printing device, during the working process of decryption up to the printing onto the recording medium.

In high-capacity printing, computer programs are often used with which the print image may be viewed before printing. These programs are designated as “viewers” and simulate the rastering of the image data as it is implemented at the printing apparatus in order to present the print image as exactly as possible, as it will be printed later onto a recording medium. A user who uses such a viewer normally also has read rights in order to completely present the print image.

A method and an arrangement for unlocking and configuration of specific processes of a printer or copier are described in from DE 10 2006 012 677 A1 or the corresponding US 2010/022 595 3 A1. The printer or copier may be operated in at least two different operating modes. At the apparatus (printer or copier), an interface is provided at which a specific electrical connection is adjustable via a plug connector arrangement, such that the apparatus is switched into a specific one of the operating modes. For example, these operating modes are designed for implementation of specific operating or diagnosis functions, service tasks, production tasks or configuration tasks.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates a device configured to control access to files, such as encrypted files that are stored in a data storage in a computer system, according to an exemplary embodiment of the present disclosure.

FIGS. 2 and 3 illustrate flowcharts of conversion methods according to exemplary embodiments of the present disclosure.

FIG. 4 illustrates a flowchart of a copy method according to exemplary embodiments of the present disclosure.

FIG. 5 illustrates a flowchart of a print method according to exemplary embodiments of the present disclosure.

The exemplary embodiments of the present disclosure will be described with reference to the accompanying drawings.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

An object of the disclosure is to achieve a method to control the type of access to secure files that are stored on a data storage in the computer system, wherein on the one hand a very high degree of security is achieved and on the other hand a flexible processing of files is possible.

Given the methods for controlling access to secure files that are stored on a data storage in a computer system according to exemplary embodiments of the disclosure, the stored files are accessed with an application. The methods can be characterized in that the files may be accessed only with a key, and upon execution of any application a check is made—using access information linked with the key—as to whether the execution of the application is authorized.

Secure files are files that are stored on a data storage such that access to the files can be limited (e.g., access possibly only with a specific key). The files may be encrypted such that they may be decrypted with the key. The files may also be stored unencrypted on the data storage, wherein the functions with which such a secure file may be accessed may only be executed with the key. The access to the files is hereby also secured with the key. The files may also be stored such that they are stored encrypted on the data storage, and the functions are only executable with a key, wherein two different keys or the same key may be provided for decryption and for execution of the functions.

The access information may either be included directly in a key or be stored in the computer system and linked with the respective key, whereby different access information may be established with different keys. Different keys may hereby be associated with users or user groups, and different access capabilities may be achieved for the files stored on the hard disk. The encrypted files may be decrypted and/or the access to the files may be unlocked with the key. A key owner hereby in principle only has access to files that are encrypted with the respective key or may be read with the respective key. Via the provision of multiple keys that are associated with different users or user groups, secure files may be stored on a data storage, to which secure files only the respective user or the respective user group that is associated with the key has access.

Operating systems can have a secure kernel. In UNIX, this secure kernel is referred to as a “kernel.” There are operating system interface functions with which functions or routines of the secure kernel may be called.

Furthermore, there are program library functions which use operating system interface functions in order to communicate with the kernel of the operating system. The program library functions are provided by program libraries which include a collection of subprograms and routines that here are designated as program library functions that offer solutions to thematically connected problems.

Applications are computer programs (shortened to “programs”) that have a sequence of instructions that satisfies the rules of a specific programming language in order to execute specific functions or tasks with the aid of a computer. Applications may call program library functions, operating system interface functions and other operating system commands. Program library functions and operating system interface functions are commonly designated with the term “functions”.

In a rights systems, a problem may exists that—given the presence of read rights to a specific file which is stored encrypted—this is decrypted automatically using the corresponding key and is freely made available to the user in decrypted form. The user may then further process the decrypted file at their discretion and store it on arbitrary data media. These data media may be removed from the system, and thus the decrypted file may be transferred to additional systems that are not secure.

In exemplary embodiments of the method, either all applications or all operating system interface functions are checked for their access authorization to the respective file. In that all applications or functions are respectively checked at a program level (applications, operating system interface functions), it is ensured that any access to a secure file may be executed only with a corresponding key. All applications, and a portion of the operating system interface functions or a portion of the applications, may also advantageously be checked for their access authorization.

The authorizations to access files via the access information linked with the key are preferably limited exclusively to the files that can be unlocked or decrypted with the respective key. It is hereby ensured that files for which a person has no key cannot be read, copied, moved or otherwise manipulated.

In an exemplary embodiment, different users or user groups may on the one hand store encrypted files on a common computer system and process these files, wherein none of the users or no member of a user group may process or in any way manipulate a secure file of another user or of another user group without permission. Since, upon execution of an application, a check is made as to whether a corresponding authorization is present, it is possible on the other hand to permit complex processing steps with which the files are processed, wherein it is simultaneously ensured that the files are not read, moved, manipulated or copied in an unauthorized manner. If the computer system is part of a printing system, for example, it is then possible to allow the users to process the print images to be printed, wherein there are hereby the most varied processing capabilities (for example changing resolution, color composition, content, run etc., or linking with other print images, sorting print jobs etc.). A versatile processing of the files is thus enabled, and at the same time it is ensured that no unpermitted information may be stolen.

In an exemplary embodiment, the check of the execution of the application may take place according to one or more of the following criteria:
rights that are related to the application,
rights that are related to the functions included in the application,
rights that are related to attributes regarding the application or functions included in the application.

In an exemplary embodiment, rights that directly relate to the application itself may be established in the access information. That is, whether the application may or may not be executed as such is regulated with these rights. Furthermore, the rights may be related to functions included in the application, in particular, operating system interface functions. An application may include (i.e. call) one or more functions such that they are executed. Rights may be established for the individual functions. For example, functions that execute a copying of the files may in principle be forbidden for specific users or user groups. Furthermore, attributes regarding applications or functions included in the applications may also be taken into account with the rights. For example, in one application for storing a file the storage location defined in an attribute may be relevant to the execution capability of the respective application. If a secure file should be stored on an internal data storage of the computer system, this is then normally permitted, in contrast to which a storage location outside of the computer system is normally not allowed. Different keys are preferably used for securing or encrypting the files, such that different persons or groups of people may—independently of one another—access only the respective files.

In an exemplary embodiment, a computer system is used in which a security identification number is associated with the hardware modules (e.g., hard disk, solid-state disk/drive (SSD)) that form the internal data storage, such that a data storage newly connected to the computer system must be registered with the operating system and allowed. This permission may normally be given by a user authorized for this. In an exemplary embodiment, an operating system may have access to a hard disk with security identification number if the operating system identifies and/or authorizes the hard disk. It is therefore prevented that—with a “bootable” data medium—the computer can be started up with an operating system that does not check the applications.

In an exemplary embodiment, individual files may only be secured or encrypted with a single key. It is hereby ensured that the content of the files may be accessed only with this one key. All access information are also established with this one key, such that how the respective file may be modified is unambiguously established with this.

In an exemplary embodiment, on the other hand, it may also be reasonable to secure or encrypt a file with one or more keys. Given securing with multiple keys, the file may be decrypted with one of these respective keys. Different persons or groups of people with whom a respective one of the keys is associated may hereby access and read this file. In an exemplary embodiment, the multiple persons or groups of people may have different access rights that are defined by different access information in the different keys.

In an exemplary embodiment, the authorization for decryption may also relate only to a portion of a document. For example, this makes sense given printing of content excerpts so that an operator may essentially view the entire content excerpt at a viewer but cannot see the individual amounts/portions. For example, this may be executed such that the regions that include the amounts are provided with a mask, wherein the masked regions are encrypted differently than the unmasked regions. For example, a different key may be used to encrypt the masked regions than is used for the unmasked regions. All regions may also be encrypted with a first key, and the masked regions may additionally be encrypted with a second key.

In an exemplary embodiment, there is a predetermined association of keys and a computer system with logged-in users, such that a specific user may use only one or more keys specifically associated with him.

In an exemplary embodiment, different encryption methods may be used to decrypt different encrypted files. Via the provision of different encryption methods, the manipulation by users not authorized for the respective file is even more difficult.

In an exemplary embodiment, the checking of the execution of the applications is executed by an operating system or a routine linked with the operating system.

In an exemplary embodiment, the method may be designed such that unsecured or unencrypted files are stored exclusively in a volatile working memory. It is hereby ensured that the files (or the data included in the files) cannot be stolen via a physical intrusion into the computer system.

Via the checking of operating system interface functions it may be prevented that an application may read and copy encrypted data stored in main memory of another application.

In an exemplary embodiment, predetermined actions that handle the files in their entirety (and therefore require no decryption of the files), such as copying, moving etc., may also be executed without decryption of the respective encrypted file. The corresponding applications are designed such that, in principle, no decryption of the files occurs given these actions.

In an exemplary embodiment, a user at the computer system is authorized with a key stored on an external data medium before an action may be executed at the computer system. This key, or an additional key stored on the external data medium, is used to decrypt one of the files stored on the data storage of the computer system. In an exemplary embodiment, no copy of this key is stored on a non-volatile data storage of the computer system.

With this external data medium, a user may be authorized at the computer system and the user may access only the files readable or decrypted with this key.

The disclosure is also directed to a computer system having a data storage, wherein the computer system has a program module that is designed to execute one of the methods explained above. In an exemplary embodiment, the program module includes processor circuitry configured to perform the functions and/or operations of the program.

In an exemplary embodiment, the data storage for storing encrypted files is a non-volatile data storage. A non-volatile data storage is a data storage that holds the data stored thereupon even if the computer is powered off. A volatile data memory is a data storage that holds the data stored therein only as long as the data storage is supplied with current/power. The working memory of a computer is most often designed as a volatile data memory (RAM), but is not limited thereto.

In an exemplary embodiment, the computer program product is configured such that a decrypted version of one of the secure files is stored exclusively in a volatile memory.

In an exemplary embodiment, the computer system includes an interface for an external data medium, in particular for an external data medium on which a key is stored.

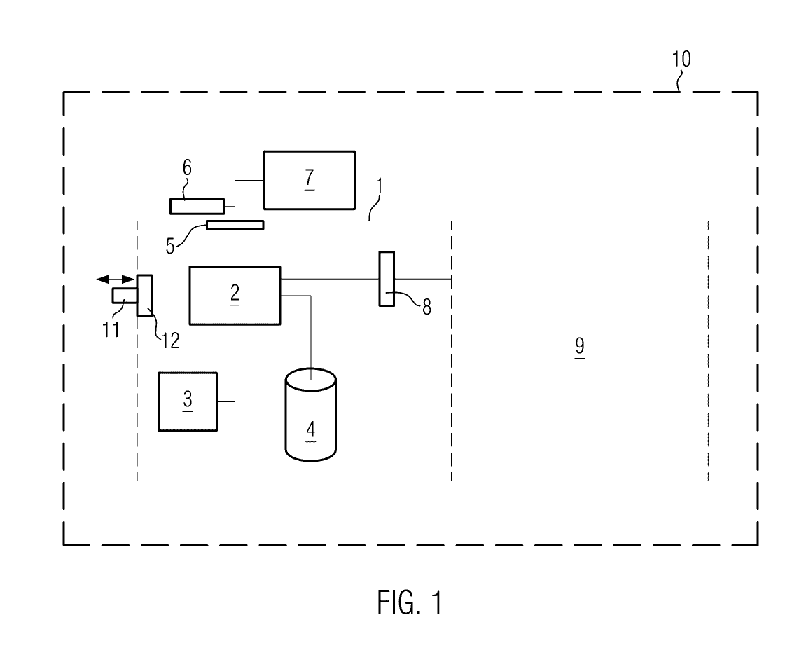

FIG. 1 illustrates a device according to an exemplary embodiment of the present disclosure. In an exemplary embodiment, the device configured to control access to encrypted files is a computer system 1.

In an exemplary embodiment, the computer system 1 comprises a central processor unit 2 (CPU), a volatile working memory 3 (RAM) and a non-volatile data storage 4. The non-volatile data storage 4 may be a conventional hard disk, semiconductor hard disk (SSD), or another non-volatile data storage as would be understood by one of ordinary skill in the relevant art. In an exemplary embodiment, the computer system 1 includes processor circuitry configured to perform one or more operations and/or functions of the computer system 1.

In an exemplary embodiment, the computer system 1 includes an interface 5 configured to connect an input device 6 (e.g., keyboard, mouse, trackpad, etc.) and/or an output device 7 (e.g., monitor, speaker, etc.). The interface 5 can also be configured to interface with one or more external storage devices (e.g., external hard disk, flash memory, SSD, optical drive, etc.).

In an exemplary embodiment, the computer system 1 includes an interface 8 configured to interface with a printing apparatus 9 (e.g., printer). In an exemplary embodiment, the computer system 1 may also have an outgoing data line (not shown) via which the print data can be supplied to the computer system.

In an exemplary embodiment, the computer system 1 and the printing apparatus 9 are located in a room 10 (e.g., hermetically sealed room) to which only persons with particular authorization have access. A printing station with such a computer system 1 and a printing apparatus 9 is provided to print confidential information onto recording media. For example, such confidential information may be access data for electronic access to a bank account or confidential financial data (for example tax assessments or the like). The persons who have the authorization to enter the room 10 should on the one hand execute, control or monitor printing processes at the printing apparatus 9, or on the other hand handle the printed recording media. Persons who should execute, control and monitor the print jobs possess an external data medium 11 on which a data key is stored. Such a data medium is also designated as a dongle 11. The computer system 1 has an interface 12 configured to interface with the dongle 11. The dongle 11 may be coupled so as to be removable. In the present exemplary embodiment, the interface 12 is designed as a plug connector (e.g., USB interface) at which the dongle 11 can be mechanically plugged in. The interface 12 may also be a radio connection, and the dongle 11 may be realized as an RFID chip. The interface 12 and dongle 11 are not limited to mechanical and RF connections and can be other types of interface-dongle connections and can be other types as would be understood by one of ordinary skill in the art.

In an exemplary embodiment, the user is authorized at the computer system 1 in that they connect dongle 11 to the interface 12. The data key stored on the dongle 11 is hereby read out and stored in a volatile working memory 3.

In an exemplary embodiment, the interface 12 can be an identification reader (e.g., RF reader, a fingerprint or other biometric reader, keypad, etc.) and the dongle 11 can be an identification (e.g., security badge, fingerprint, password, etc.) In this embodiment, the data key associated with the user/user ID is stored in non-volatile data storage 4 and provided to the volatile working memory 3 when the user is authenticated with the computer 1. The data key can be encrypted when stored in the storage 4 and the decrypted when transferred to the memory 3.

In an exemplary embodiment, the data key includes a key identification number, one or more encoding keys, access information that describes the allowed applications and/or functions. This access information may be a short identifier that jumps/branches/links to a detailed description of the allowed applications and functions, which description is stored at the computer. It may also include a list of all applications and/or functions that may be used, wherein the scope of the individual uses may also be established.

In an exemplary embodiment, the scope of the use of the individual applications and/or functions defined in the access information may also be dependent on an additional identifier to be input by the user, such that users with the same key may receive a different scope of authorization due to different identifiers. These identifiers may be provided for individual persons or for groups of people.

In an exemplary embodiment, an operating system, which may be stored on the computer system 1, is executed on and by the computer system 1. Furthermore, one or more applications or application programs are stored and executable. The applications include a sequence of instructions that may include operating system commands, program library functions and/or operating system interface functions.

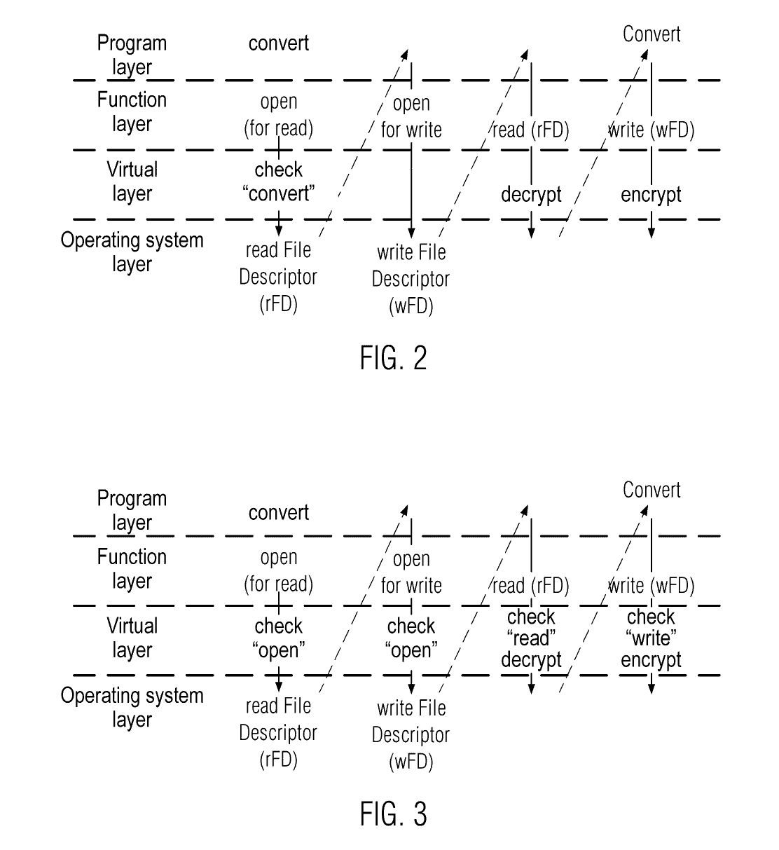

In an exemplary embodiment, upon invoking an application, the execution of the sequence of instructions is started. FIGS. 2 through 5 show this schematically, in a layer model, wherein the uppermost layer is respectively the program layer in which the applications (for example conversion, copying, printing) and operating system commands are executed. Located below the application layer is the function layer, in which the respective functions (for example program library functions and/or operating system interface functions) which are called upon execution of the superordinate applications are executed.

Under the function layer there is a virtual layer in which a check of the applications and/or functions (whether they are authorized to be executed) is implemented. Located below the virtual layer is the operating system layer in which the kernel functions of the operating system are executed. This is a schematically simplified layer model that does not correspond to the ISO standard. However, it is very well suited for explanation of the present disclosure.

The present exemplary embodiment uses UNIX or a UNIX derivative as an operating system, but is not limited thereto (and can be, for example, Windows, iOS, Chrome, etc.). The virtual layer includes a check routine which is linked to a kernel of the operating system with a kernel hook. In principle, it is also possible to completely integrate this check routine into a secure kernel of the operating system. The virtual layer would then be omitted.

In an exemplary embodiment, the operating system is designed and/or configured such that at least predetermined files (for example in specific directories) and all files are stored encrypted in the non-volatile data medium. The decryption and encryption of the files is performed by the operating system or by the routines in the virtual layer insofar as a suitable key is made available.

In an exemplary embodiment, such a key or data key is linked with access information which defines under what circumstances or conditions the respective application or function may be executed.

In an exemplary embodiment, the access information is encoded in the key itself. However, a table with all access information and their linking with the respective keys may also be stored in the computer system 1, such that the access information belonging to the respective key are read given a checking of an application or a function.

If an application is invoked, a check is then made as to whether the access information belonging to this application allows the execution of the application. FIGS. 2 through 5 show typical examples. However, the disclosure is not limited to these examples. In principle, all applications or functions are checked as to which access data or process this data in some manner.

Since the writing of data to a data medium is always executed in the kernel of the operating system, and therefore may be executed by the applications exclusively with an operating system interface function, it may be sufficient to check only the operating system interface functions in order to ensure that data are not impermissibly written to an unapproved data medium. Therefore, in a preferred embodiment of the method only the operating system interface functions are checked as to whether their execution is authorized. It may hereby be reliably prevented that an unapproved data medium is written to with an application in an unwarranted manner.

FIG. 2 shows an example of the method according to the disclosure using the “conversion” application, with which a file should be converted from one predetermined format into another predetermined format.

The “conversion” application includes the operating system interface functions “open (for read)”, “open (for write)”, “read” and “write”.

With the “open for read” operating system interface function, the pointer (=Read File Descriptor) of the file to be read that should be converted is obtained and provided to the next operating system interface function, “read”. The pointer includes the address information at which the file is stored. This address information may be an address identification number that is translated by the operating system into a physical storage address. The pointer may include additional information, such as an identification number of the file or a specification of a buffer in which the file is stored.

With the “open for write” operating system interface function, the pointer (=Write File Descriptor) of the storage region to which the converted file may be written is obtained in order to be provided for the “write” operating system interface function.

The file is read with the “read” operating system interface function, wherein it is automatically decrypted with the key of the user who has invoked the “conversion” application command. The decrypted file is stored in volatile working memory 3 and there is converted by the “convert” command into a different data format, and subsequently is stored on the data storage 4 with the “write” operating system interface function, wherein the operating system automatically encrypts the file with the key upon storing.

Upon calling the first operating system interface function, an application is checked as to whether this application (here “conversion”) may be executed. Given this check, the access information linked with the key is evaluated. In the present example, a check is made as to whether the “conversion” application itself may be executed. If it is defined in the access information that the application may not be executed, the execution of the application is terminated before the first operating system interface function is completely executed. A corresponding error message is output. Otherwise, the application is executed.

In this exemplary embodiment, all applications are checked, using the access information, as to whether and to what extent they may be executed. If a new application is created by one of the users, then it is appropriate to subject this application to a predetermined approval process wherein the access information takes the new application into account as well.

FIG. 3 shows a modified form of the checking of the execution of the “conversion” application. Here as well, the “conversion” application is made up of four operating system interface functions (open for read, open for write, read, write). The basic structure of this application is the same as in FIG. 2, which is why the individual method steps are not explained again. However, in this exemplary embodiment it is not the application itself that is checked but rather every individual operating system interface function. Upon calling the “open for read” and “open for write” operating system interface function, a check is made as to whether an authorization exists for execution of this operating system interface function.

In an exemplary embodiment, in the checking of the “open for read” operating system interface function, a check is made as to whether
the access to a file, a port or an IP address is allowed,
the file or the data are encrypted, and/or
keys for decryption are present.

In an exemplary embodiment, in the checking of the “open for write” operating system interface function, a check is made as to whether
the target for the application is permitted (registered), wherein the target may be a data medium, a port or an IP address is allowed,
the writing to the target is allowed, and/or
the key for encryption or writing is present.

In an exemplary embodiment, a similar check is executed upon calling the “read” operating system interface function for the “read” operating system interface function, and upon calling the “write” operating system interface function for the “write” operating system interface function, wherein this check may be shortened if the checking of the corresponding “open” operating system interface function is accessed in the check results. Computation time may hereby be saved with the “write” and “read” operating system interface functions.

In this exemplary embodiment, all operating system interface functions (and not the applications themselves) are directly or indirectly checked via reference to corresponding check results. The access information thus here does not describe whether the “conversion” application is itself executable, but rather whether the individual operating system interface functions may be executed.

In the exemplary embodiment according to FIG. 3, the execution of the respective applications may be terminated after the respective calling of the operating system interface function that may not be executed. Here, the application is thus not always terminated at the first operating system interface function in the event that it should be terminated.

As a result, both embodiments correspond to one another. However, it is advantageous that either all applications that access data or process these data are defined in the access information with regard to an authorization, or that all operating system interface functions that access data or process these data are defined in the access information with regard to an authorization. It is hereby ensured that an unauthorized handling of files—in particular an unpermitted manipulation or a theft of files—is not possible via a combination of applications or a combination of operating system interface functions.

In an exemplary embodiment, given the checking of all operating system interface functions, it is advantageous that the operating system interface functions are limited and users may not generate new ones, such that it is not necessary to define a process similar to that for new applications in order to modify the access information. The checking of all operating system interface functions is therefore more secure than that of all applications.

In principle, it is also possible to establish the authorization of all applications, and simultaneously of all operating system interface functions, with the access information.

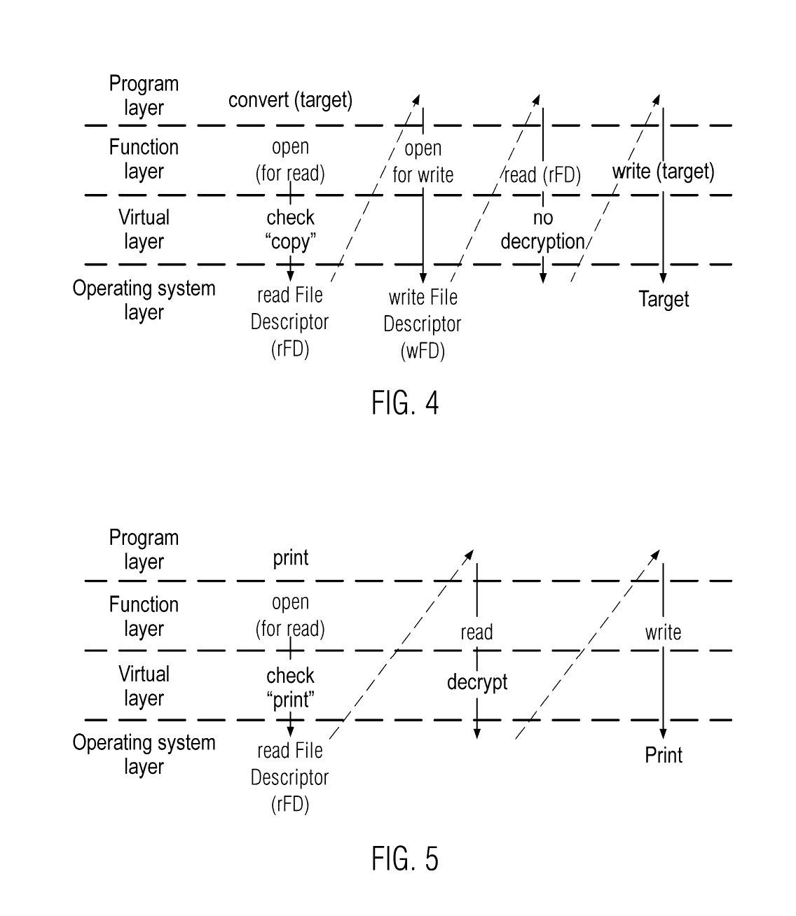

FIG. 4 shows as an example the “copy” application, which is invoked with the “target” attribute. The “target” attribute describes the location at which the file should be stored.

The “copy” application includes the operating system interface functions “open for read”, “open for write”, “read” and “write”. In this application, the “read” operating system interface function is executed such that no decryption of the respective file occurs. To copy a file it is not necessary that this be decrypted, since the data that are contained in the file do not need to be individually accessed; rather, the file is processed as a whole. The “write” operating system interface function writes the file to the desired location depending on the target.

If it is desired to pass the file from one user to another user with whom different keys are associated, a decryption and encryption is then executed upon copying, wherein the different keys are used. Such a decryption and encryption is defined in the access information, such that files in a form readable to the user may only be exchanged between specific users.

In this exemplary embodiment as well, the check as to whether the application may be executed takes place using the application itself, as in the exemplary embodiment shown in FIG. 2. That is, the access information define whether the respective application is executable or not.

In an exemplary embodiment, the “target” attribute is also considered in the checking of the application. For example, the access information may define that the file may be freely copied within the computer system 1 but may not be copied to an external storage. Specific targets within the computer system 1 may also be excluded from copying. If the file should be copied to an unauthorized target with the “copy” application, this is established upon checking the authorization, and the application is terminated before the first operating system interface function is completely executed.

In an exemplary embodiment, the access information may thus define for specific keys an authorization to execute a specific application or a specific operating system interface function in combination with additional criteria, in particular attributes, which are passed upon invoking an application.

FIG. 5 shows an example of the “print” application command. This application command is very similar to the “copy” command, since it again includes the three operating system interface functions “open for read”, “read” and “write”. Here, however, the “read” operating system interface function is executed such that the file is decrypted with the key in the event that the user has the valid key. The “write” operating system interface function then writes the decrypted file to a (network) port at which the data is immediately sent to the printing apparatus. The decrypted print data are never stored outside of working memory. If the user has the authorization to print files at this system, he may then execute this application. Otherwise, he is interrupted upon checking the authorization for execution of this application.

In an exemplary embodiment, in the respective checking of the applications, a check is also made as to whether the key of the user who has been authorized at the computer system is the key with which the file which should be accessed may be decrypted. If an application is invoked wherein the key is not that with which the file can be decrypted, the application is terminated regardless of whether the application decrypts the file upon execution (FIGS. 2, 3, 5) or does not decrypt it (FIG. 4). It is hereby ensured that a user of the computer system 1 cannot modify or read a file for which he has no suitable key.

In an exemplary embodiment, individual files may also be encrypted with multiple keys with which they may be decrypted independently of one another (single-factor protection). Different access information for different people and user groups may hereby be defined for the same file.

In an exemplary embodiment, individual files may also be encrypted with multiple keys with which they may only be jointly decrypted (multi-factor protection). Different access information of different people and user groups may hereby be necessary for reading, moving, copying or manipulating the file.

Exemplary embodiments are described above using a printing system. The disclosure is also suitable for other uses. For example, the disclosure is also suitable for banking systems on which customer data are processed. With the present disclosure, the individual users may be allowed the execution of the most varied applications for processing of the files, wherein special applications or special circumstances under which applications are executed may, however, be excluded. These in particular pertain to applications and statuses of applications with which data may be stolen from the computer system, in particular data that may be stored on an external data medium.

Given the exemplary embodiments explained above, the data stored on the data storage 4 are encrypted. Within the scope of the disclosure, it is also possible to store the data unencrypted on the data storage 4 insofar as the access to the files is controlled by means of the key, such that the files may not be read and processed further without such a key.

In an exemplary embodiments, a closed system in which all instructions and functions with which data are processed is provided to the users; an authorization is associated with the access information so that any processing of data of the files stored in the data storage 4 is checked with regard to the authorization. On the one hand, a high level of data security is hereby achieved, but on the other hand the individual users are provided with a multitude of executable applications in order to be able to fulfill the respective tasks.

Given conventional systems, an administrator can in principle read all files. This is already necessary solely so that the administrator can back up the data set, wherein the data set is copied onto a backup data medium. Given conventional systems, the administrator thus has access to all files.

With the disclosure, the administrator can be allowed to copy to a backup data medium, optimally without decryption. However, he can be prohibited from otherwise decrypting, viewing or forwarding the data.

In an exemplary embodiments, methods and computer systems to control access to secure files that are stored on a data storage in the computer system are described. The stored files can be accessed with an application. The files may be read with a key. In an exemplary embodiment, upon execution of any application, using access information linked with the key, a check is made as to whether the execution of the application is authorized.

### CONCLUSION

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, processor circuitry can include one or more circuits, one or more processors, logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. In one or more exemplary embodiments, the processor can include a memory, and the processor can be “hard-coded” with instructions to perform corresponding function(s) according to embodiments described herein. In these examples, the hard-coded instructions can be stored on the memory. Alternatively or additionally, the processor can access an internal and/or external memory to retrieve instructions stored in the internal and/or external memory, which when executed by the processor, perform the corresponding function(s) associated with the processor, and/or one or more functions and/or operations related to the operation of a component having the processor included therein.

In one or more of the exemplary embodiments described herein, the memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

1 computer system
2 central processing unit (CPU)
3 working memory
4 data storage
5 interface
6 input device
7 output device
8 interface
9 printing apparatus
10 hermetically sealed room
11 dongle
12 interface

We claim:

1. A method to control access to secure files that are stored on a data storage located in a computer system for storage of files, the stored files accessible with an application, the method comprising:
accessing, with a key, the secure files; and
checking, using access information linked with the key, whether the execution of the application is authorized upon execution of the application.

2. The method according to claim 1, wherein the checking of the execution of the application is performed according to one or more of the following criteria:
rights that are related to the application;
rights that are related to functions included in the application, in particular operating system interface functions; and
rights that are related to attributes for the application or functions included in the application.

3. The method according to claim 2, wherein the functions included in the application comprise operating system interface functions.

4. The method according to claim 2, wherein the attributes comprise:
a storage location at which a file of the secured files to be accessed is to be stored, or
a file format into which the file is to be converted.

5. The method according to claim 1, wherein different keys are used to encrypt the secured files.

6. The method according to claim 5, wherein a file of secured files is encrypted with only a single key.

7. The method according to claim 5, wherein a file of the secured files is encrypted with a plurality of keys.

8. The method according to claim 5, wherein a predetermined association of keys and users logged into the computer system is used so that a specific user may use only one or more specific keys.

9. The method according to claim 1, wherein different encryption methods are used to decrypt different secured files.

10. The method according to claim 1, wherein the checking of the execution of individual applications is executed by an operating system or a routine linked to the operating system.

11. The method according to claim 1, wherein decrypted files are stored exclusively in a volatile working memory.

12. The Method according to claim 1, wherein actions that do not require decryption of the files are executed without decryption of a respective file of the secured files.

13. The method according to claim 1, wherein:
a user must be authorized at the computer system with a key stored on an external data medium before the user may execute an action at the computer system; and
the key or an additional key stored on the external data medium or the computer system is used to access or decrypt one or more files stored on the data storage of the computer system.

14. A computer system having a data storage and computer program module, the program module being configured to execute the method according to claim 1.

15. The computer system according to claim 14, further comprising a volatile memory, wherein:
the data storage is a non-volatile data storage configured to store encrypted files; and
the computer program module is configured to store decrypted versions of the encrypted files exclusively in the volatile memory.

16. The computer system according to claim 15, wherein the computer system further comprises an interface configured to interface with a dongle.

17. The computer system according to claim 16, wherein the dongle is configured to authenticate a user of the computer system.

18. A printing system comprising a computer system and a printer, the computer system having a data storage and computer program module and being configured to transmit print data to the printer, wherein the program module is configured to execute the method according to claim 1.

19. A non-transitory computer-readable storage medium with an executable program stored thereon, wherein the program instructs a processor of the computer system to perform the method of claim 1.
